(19) United States
(12) Patent Application Publication
(10) Pub. No.: US 2010/0071336 A1
(43) Pub. Date: Mar. 25, 2010

(54) Sprockets And Chains For A Row Unit

(76) Inventors: Timothy Franklin Christensen, Moline, IL (US); Steven Timothy Rieck, Cambridge, IL (US)

Correspondence Address: DEERE & COMPANY, ONE JOHN DEERE PLACE, MOLINE, IL, 61265, US

(21) Appl. No.: 12/468,368

(22) Filed: May 19, 2009

Related U.S. Application Data
(60) Provisional application No. 61/099,544, filed on Sep. 23, 2008.

(51) Int. Cl. A01D 69/00; A01D 45/02

(52) U.S. Cl. 56/98

(57) ABSTRACT

A row unit gathering chain has a number of links that is an integral multiple of the number of teeth on the sprocket on which it is mounted.

### CROSS REFERENCE TO RELATED APPLICATIONS

This is a non-provisional application based upon U.S. provisional patent application Ser. No. 61/099,544 entitled “Sprockets And Chains For A Row Unit”, filed Sep. 23, 2008, which is incorporated herein by reference.

### FIELD OF THE INVENTION

This invention relates generally to agricultural harvesters. More particularly, it relates to corn heads for agricultural harvesters. Even more particularly, it relates to gathering chains and sprockets for row units.

### BACKGROUND OF THE INVENTION

Row units for the corn heads of agricultural harvesters are used to gather a row of corn plants, sever the upper portion of the corn plants, and strip the cornstalk from the ears of corn on the upper portion of the corn plant, saving the ears of corn and sending them to the agricultural harvester for further processing. This further processing includes threshing, cleaning and separating the kernels of corn from the corn cobs and saving them in a grain tank on the agricultural harvester. Corn stored in the grain tank is then transferred to a grain cart or truck, which then takes the corn to a storage bin remote from the field.

Each row unit includes devices for guiding the severed stalk of the corn plant rearward between 2 row unit arms which support stalk rolls (also known as stripping or stripper rolls). The stalk rolls are two generally cylindrical elongate members that rotate next to each other to grasp the cornstalk, pull it downward, and eject it into the ground, while stripping off the ears of corn from the stalk itself.

Each of the 2 gathering chains on a row unit is supported on two sprockets, and is driven such that the chains face each other above a gap between the 2 stalk rolls. The chains have several pusher links with integral protrusions that extend to one side of the link into the gap between the row unit arms. These pusher links push the severed cornstalks through the row unit. Each of the pusher links has a flat surface facing in the direction of travel and extending partially into the gap that is configured to engage the cornstalk adjacent to the ground where it is covered with earth, grit, and sand as the agricultural harvester moves through the field. Adjacent pusher links are spaced apart along the gathering chains by a plurality of regular links (i.e. links that do not extend toward/into the gap between the row unit arms).

The gathering chains and the sprockets that carry them experience significant wear. As the pusher links push against the cornstalk, moving it forward through the gap, the 2 stalk rolls engage the severed shaft of the cornstalk and pull it downward, rubbing it against the surface of the pusher lank as it is pulled downward. This wears the pusher link and also causes dirt and grit to be dislodged and embedded in the pusher link.

Due to this wear, the gathering chains must therefore be periodically replaced along with the sprockets, which are also worn by continual engagement with the worn links of the gathering chain. The gathering chains and sprockets interact with each other, and wear into each other such that they must be replaced as a pair. Any flaw on a single link eventually engages and wears all of the teeth of the sprockets. This sprocket wear due to a brakeman by worn chains eventually requires that both the chain and the sprocket be replaced.

The applicants for the present invention have discovered a relationship between sprocket wear and gathering chain wear. The knowledge of this relationship has permitted the applicants to devise a new row unit, sprocket, and gathering chain arrangement that reduces wear.

It is an object to provide gathering chains configured to engage particular sprockets. It is an object to provide sprockets configured to engage particular gathering chains. Is an object to provide a row unit having a particular gathering chain and sprocket arrangement.

### SUMMARY OF THE INVENTION

There are several inventions disclosed herein. These inventions are recited below.

In accordance with a first aspect of the invention, a gathering chain for a row unit having two sprockets with exactly N teeth is provided, the gathering chain having pusher links that are spaced N links apart and for their having a total number of links sufficient to be supported on the two sprockets of the row unit, wherein the total number of links in the gathering chain is an even multiple of N.

In accordance with a second aspect of the invention, a sprocket for a row unit is provided, the sprocket having exactly N teeth, the central aperture being configured to be supported for rotation on a shaft of the row unit, and being configured to guide a gathering chain on the row unit having an even multiple of N links. the row unit being configured to support a gathering chain having a total number of links equal to an even multiple of N.

In accordance with a third aspect of the invention, a row unit is provided having a gearbox supporting two forwardly extending row unit arms, each of said arms supporting a corresponding gathering chain mounted for rotation on 2 sprockets, wherein the total number of links in the gathering chains is even multiple of N, and further wherein each of the 2 sprockets has exactly N teeth.

### BRIEF DESCRIPTION OF THE DRAWINGS

FIG. 1 is a perspective view of a row unit.

FIG. 2 is a top view of the row unit of FIG. 1.

FIG. 3 is a fragmentary detail perspective view of the forward ends of the row unit arms 106, 108.

### DETAILED DESCRIPTION OF THE PREFERRED EMBODIMENT

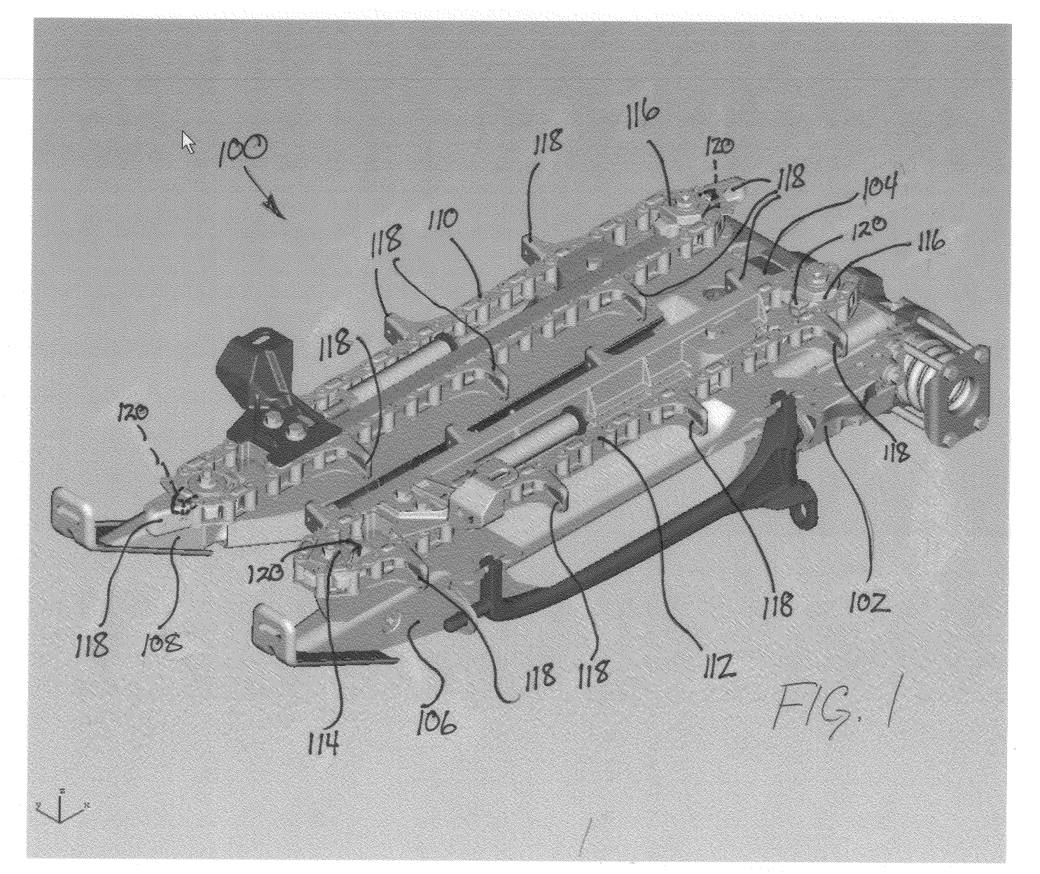

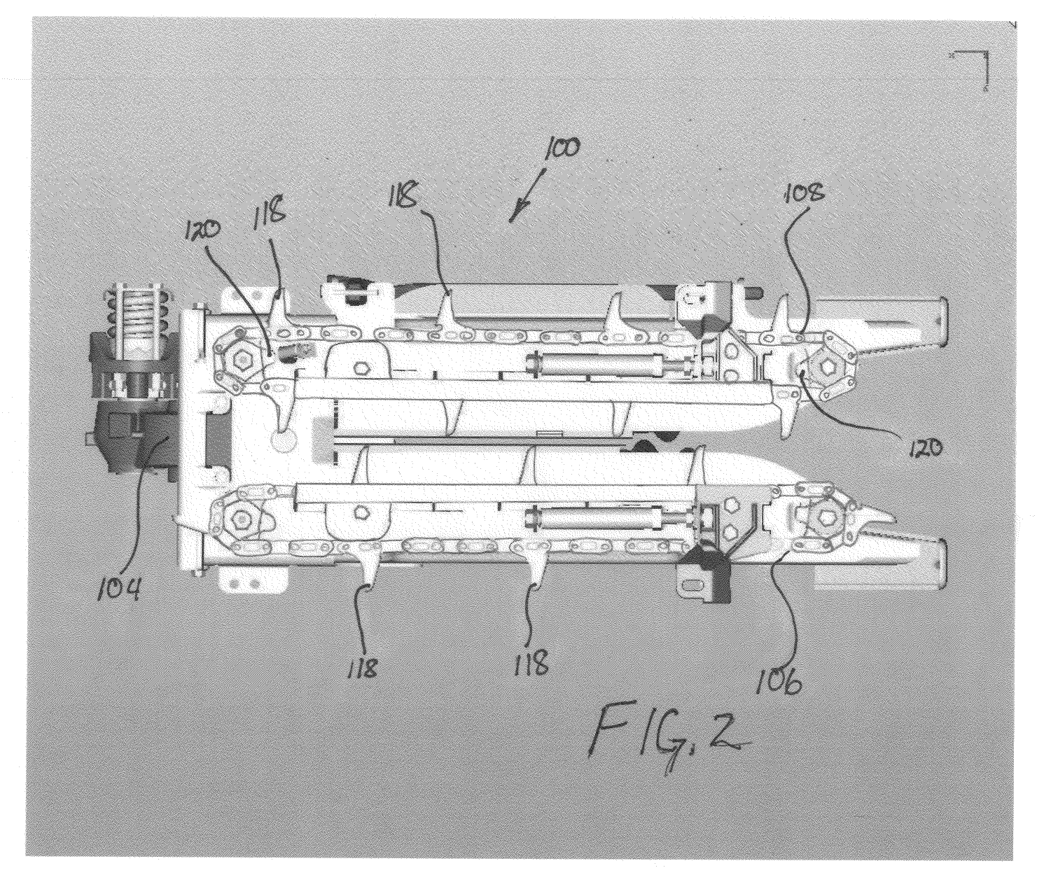

Referring now to FIGS. 1, 2, a row unit 100 is shown comprising a frame 102, including a gearbox 104 and two arms 106, 108 extending generally forward therefrom. Two gathering chains 110, 112 are supported on the row unit arms for rotation. Each gathering chain 110, 112 is supported on 2 sprockets 114, 116. Sprocket 114 is an idler sprocket mounted on the front end of the row unit arms 106, 108. Sprocket 116 is a driven sprocket, extending from the rear of the row unit arms 106, 108 at the gearbox 104.

Each of the sprockets 114, 116 has N teeth where N is an integer (e.g. 6 in the illustrated example).

Each of the gathering chains 110, 112 has a total number T links where T is an integer and in which T=M*N links and M is an integer. In the illustrated embodiment, M=8 and N=6. There are M pusher links 118 extending therefrom. The pusher links 118 are equidistantly spaced along the length of the chain, with an equal number (5 in this example) of ordinary links disposed in between each adjacent pusher link 118. In the illustrated embodiment, this pusher link-to-pusher link spacing is N links.

Given the number of links in each gathering chain, the number of pusher links in each gathering chain, and the number of teeth on the sprockets, a single tooth 120 on each sprocket will receive and support all of the pusher links 118. In this embodiment, eight.

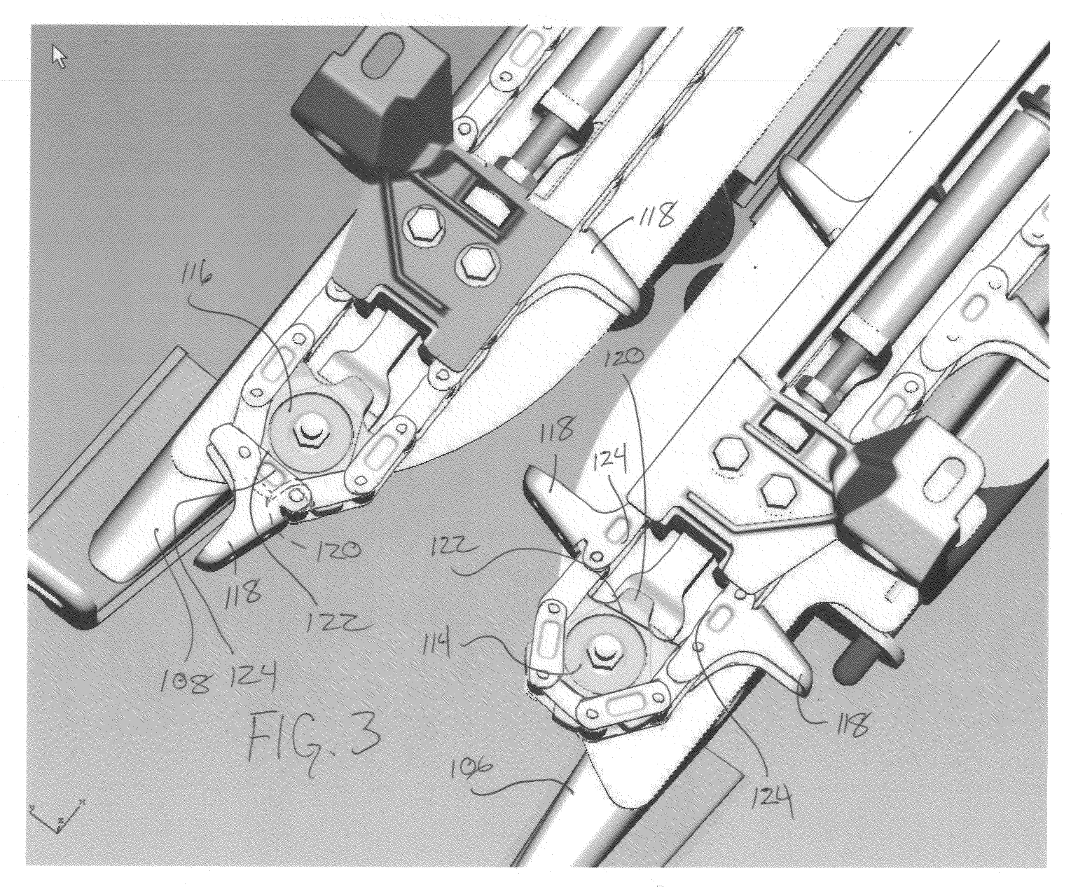

None of the other ordinary (i.e. non-pusher) links in the gathering chain will be supported on tooth 120. Thus, tooth 120 can have a physical configuration that is different than the other teeth on the sprocket and be configured to support a pusher link 118, since only pusher links 118 will ever be supported on tooth 120. For example, a support surface 122 (FIG. 3) is provided on both sides of the sprocket to support side walls 124 on each pusher link 118. A support surface 122 is disposed on both of sprockets 114, 160 and on both sides of the sprocket, to abut and support the side walls 124 on both sides of pusher link 118 when pusher link 118 is carried by either of sprockets 114, 116. Said support surface 122 is located only on tooth 120, it does not interfere with all of the other, ordinary links of the gathering chains, since it does not touch them. It engages side walls 124 of pusher links 118 only. Having a custom tooth configured to support a custom link would not be possible unless the gathering chains and sprockets were configured in the manner described herein.

For the same reason, every other tooth on the sprockets also supports exactly M individual links on the chain and no other links. Thus, as the teeth wear, they are not worn against 48 unique links, each of the 48 unique links with its own pattern of wear, each of the 48 links wearing its own individual pattern into the tooth. Instead, each tooth is worn by contact only with 8 links. Thus, every link wears against a reduced number (8 in this embodiment) of links.

The above is an example of one embodiment of the invention. Other embodiments are possible so long as they fall within the scope of the claims, below, which define the invention. For example, M need not be 8 and N need not be 6. M can vary from 5 to 15, and N can vary from 5 to 10. The particular values of M and N will vary depending upon the size of the sprockets and the length of the row unit arms. In another embodiment of the invention, a row unit in accordance with the invention may have only a single gathering chain. These and other variations of the invention are possible without departing form the claims below.

1. A harvester row unit, comprising:
an arm;
a gathering chain; and
a plurality of sprockets rotatably connected to said arm including a first sprocket and a second sprocket, each interacting with said gathering chain, wherein said gathering chain has a number of links that is an even multiple of the number of teeth on the first and second sprockets.

2. The row unit of claim 1, wherein the gathering chain has a spacing between adjacent pusher links that is equal to the number of teeth on the first and second sprockets.

3. The row unit of claim 3, wherein
all of the pusher links on the gathering chain are disposed to engage only one single tooth on each of the plurality of sprockets.

4. A gathering chain for a harvester row unit having a plurality of pusher links separated by regular links, wherein each of the plurality of pusher links is configured to engage only one tooth of a sprocket on which the chain is to be mounted and not the other teeth on the sprocket.

5. The gathering chain for a harvester row unit of claim 4, wherein the sprocket has six teeth and the chain has 48 links.

6. A gathering chain and sprocket set for a harvester row unit, comprising two sprockets, each sprocket having N teeth and a gathering chain with N times M total links and M pusher links, where N and M are integers.

7. The gathering chain and sprocket set of claim 6, wherein N equals six and M equals 8.

8. The gathering chain and sprocket set of claim 6, wherein the pusher links are evenly spaced every N links apart.

9. A gathering chain is provided for a row unit having two sprockets, each sprocket with exactly N teeth, the gathering chain having pusher links that are all spaced N links apart, wherein the total number of links in the gathering chain is an even multiple of N and N is an integer.

10. A sprocket for a row unit is provided, the sprocket having exactly N teeth, the sprocket being configured to guide a gathering chain on the row unit, the gathering chain having an even multiple of N links, wherein the row unit is configured to support a gathering chain having a total number of links equal to an integral multiple of N.

11. A row unit is provided having a gearbox supporting two forwardly extending row unit arms, each of said arms supporting a corresponding gathering chain mounted for rotation on two sprockets supported on said each arm, wherein the total number of links in the gathering chains is even multiple of N, and further wherein each of the two sprockets has exactly N teeth.
